(19) United States
(12) Patent Application Publication
(10) Pub. No.: US 2008/0282503 A1
(43) Pub. Date: Nov. 20, 2008

(54) HINGE ASSEMBLY

(76) Inventor: Chia-Hsiang CHEN, Shulin City (TW)

Correspondence Address: Rabin & Berdo, P.C., Suite 500, 1101 14th Street, Washington, DC, 20005, US

(21) Appl. No.: 11/748,643

(22) Filed: May 15, 2007

(51) Int. Cl. E05D 11/08

(52) U.S. Cl. 16/342

(57) ABSTRACT

A hinge assembly has two leaves, a pintle, at least one limit, at least one positioning element and a rotating bracket. The leaves are respectively connected securely to a cover and a base of a portable electronic device. The pintle and the rotating bracket are mounted between the leaves and allow the leaves to pivot relative to each other. The limit and the positioning element are mounted securely on the pintle and limit positions of the leaves. The rotating bracket is mounted around the pintle and covers the limit and the positioning element. With such an arrangement, the limit and the positioning element are covered. Therefore, abrasions or interference between wires or cableways and the limit or positioning element are prevented and the hinge assembly is guaranteed to last a long time and move smoothly.

### BACKGROUND OF THE INVENTION

1. Field of the Invention

The present invention relates to a hinge, and more particularly to a hinge assembly that has travel-limit or positioning functions and effectively prevents abrasion or interference between the hinge and external wires or cableways from occurring.

2. Description of Related Art

Portable electronic devices like calculators, translation machines, notebook computers, mobile phones and the like comprise a base, a cover and at least one hinge mounted between the base and the cover.

The hinge connects the cover to the base and allows the cover to rotate relative to the base. A hinge generally comprises two leaves and a pintle. The leaves are respectively connected securely to the cover and the base and have pivoting holes that correspond to each other. The pintle is mounted through the pivoting holes of the leaves allowing the leaves to pivot along a pivotal axis of the pintle.

Moreover, the hinge may have limits and positioning elements to limit the travel and position of the leaves relative to each other and improve performance. However, the limits and positioning elements are mounted without covers on the hinge. Therefore, when the hinge operates, the limits and the positioning elements cause wear to, or interfere with wires or cableways wound around the pintle of the hinge, causing damage. To overcome the shortcomings, the present invention provides a hinge assembly to obviate or mitigate the aforementioned problems.

### SUMMARY OF THE INVENTION

The main objective of the present invention is to provide a hinge assembly that has travel-limit or positioning functions and effectively prevent abrasion or interference between the hinge and external wires or cableways from occurring.

To achieve the objective, the hinge assembly comprises two leaves, a pintle, at least one limit, at least one positioning element and a rotating bracket. The leaves are respectively connected securely to a cover and a base of a portable electronic device. The pintle and the rotating bracket are mounted between the leaves and allowing the leaves to pivot relative to each other. The limit and the positioning element are mounted securely on the pintle and limit the positions of the leaves.

The rotating bracket is mounted around the pintle and covers the limit and the positioning element.

With such an arrangement, the limit and the positioning element are operated covered. Therefore, abrasions or interference between wires or cableways and the limit or positioning element are prevented and the hinge assembly in accordance with present invention is guaranteed to last a long time and move smoothly.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge in accordance with the present invention;

FIG. 2 is an exploded perspective view from a front of the hinge in FIG. 1;

FIG. 3 is an exploded perspective view from a rear of the hinge in FIG. 1;

FIG. 4 is an enlarged perspective view of the rotational bracket of the hinge in FIG. 2;

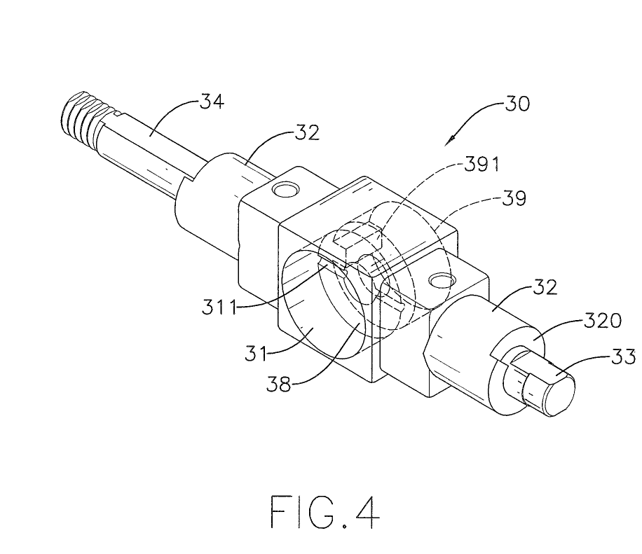

FIG. 5 is a perspective view of the hinge in FIG. 1 mounted in a portable electronic device;

FIG. 6 is an operational perspective view showing the hinge in FIG. 4 pivoting; and

FIG. 7 is an operational perspective view showing the hinge in FIG. 4 rotating.

### DETAILED DESCRIPTION OF THE PREFERRED EMBODIMENT

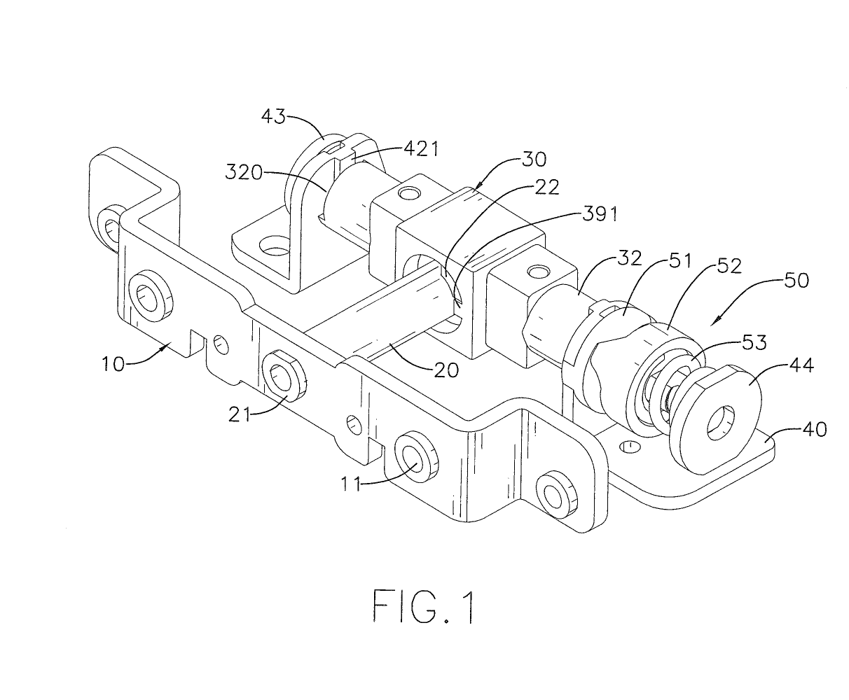

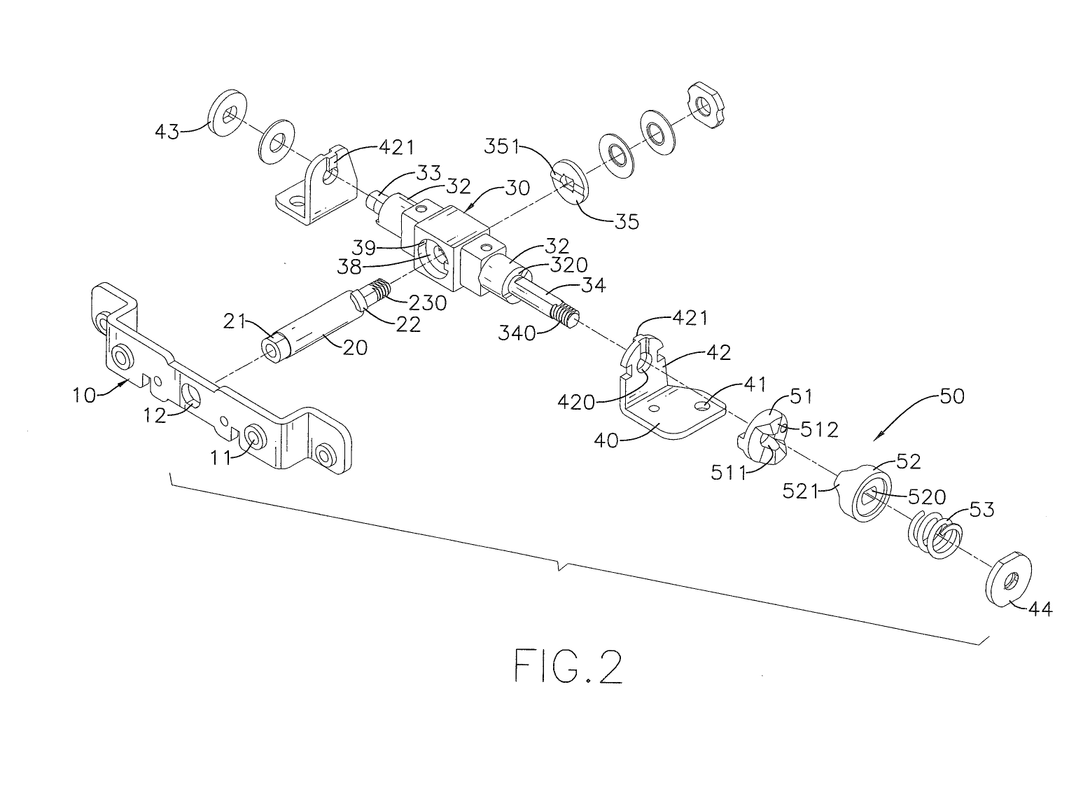

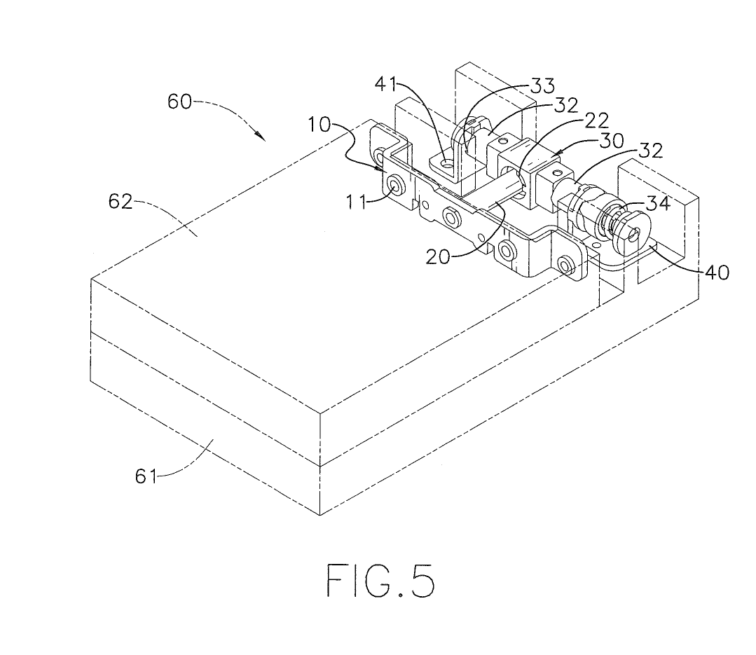

With reference to FIGS. 1, 2, 3 and 5, a portable electronic device (60) has a base (61), a cover (62) and a hinge assembly in accordance with present invention pivotally mounted between the base (61) and the cover (62).

The hinge assembly comprises a pivoting leaf (10), a pintle (20), a rotating bracket (30), a positioning element (35), a fixing element (36), multiple washers (37), two stationary leaves (40), two securing elements (43, 44), and an optional retaining assembly (50).

The pivoting leaf (10) has a middle and multiple securing holes (11) formed through the pivoting leaf (10) to mount onto the cover (62).

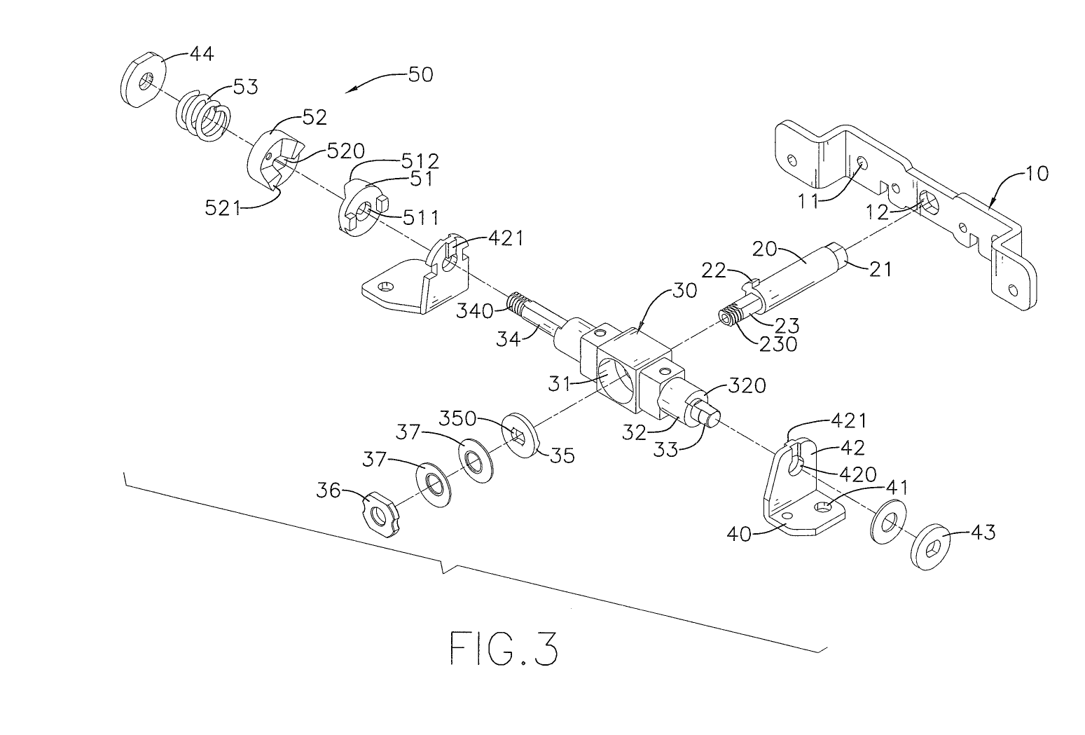

The pintle (20) has a cover end (21), a base end and a limit (22). The cover end (21) is attached to the middle of the pivoting leaf (10) by means of soldering, compression fitting, riveting or the like. The base end has a mounting portion (23) formed on and protruding longitudinally from the base end, is keyed and has an end. The end may be a threaded end (230). The limit (22) is formed on and protrudes radially out from the base end of the pintle (20). With further reference to FIG. 3, the rotating bracket (30) has an axial end, a keyed end, a center, a countersink (31), a limiting recess (39), a gudgeon (38), a pivotal axis, a rotational axis, an upper side, a lower side, two spacers (32), a key (33) and an axle (34).

The pivotal axis is defined transversely through the rotating bracket (30). The limiting recess (39) is formed in the upper side of the rotating bracket (30) along the pivotal axis and has an inner surface and a positive stop (391). The positive stop (391) is formed on and protrudes from the inner surface of the limiting recess (39) and selectively abuts the limit (22) of the pintle (20) to limit how much the pivoting leaf (10) can rotate.

The countersink (31) is formed in the lower side of the rotating bracket (30) along the pivotal axis, has an inner surface perpendicular to the pivotal axis and a detent (311) and allows the pintle (20) to be secured by the fixing element (36) without protruding out of the countersink (31). The rotational detent (311 ) is diametrically formed in the inner surface of the countersink (31).

The gudgeon (38) is formed transversely through the rotating bracket (30) along the pivotal axis has a central hole. The central hole is defined through the gudgeon (38) along the pivotal axis, and is formed concentrically to and communicates with both the countersink (31) and the limiting recess (39) and rotationally mounting around the pintle (20).

The spacers (32) may be cylindrical and respectively protrude from the keyed and axial ends of the rotating bracket (30), and each has an end surface and an optional semi-circular recess (320) formed in the end surface. The key (33) is formed on and protrudes from the end surface of one of the spacer (32) at the keyed end of the rotating bracket (30) along a rotational axis, is non circular in cross section and may be threaded. The axle (34) is formed on and protrudes from the end surface of the spacer (32) at the axial end of the rotating bracket (30) along the rotational axis, is non circular in cross section and may have a threaded end (340).

The positioning element (35) are mounted in the countersink (38) and has an inner surface, an engaging hole (350) and a ridge (351). The engaging hole (350) is non-circular and engages with the mounting portion (23) of the pintle (20) so as to rotate simultaneously with the pintle (20). The ridge (351) is diametrically formed on the inner surface of the positioning element (35) and selectively engages the rotational detent (311) of the countersink (38) to retain the position of the pivoting leaf (10) relative to the rotating bracket (30).

The fixing element (36) may be a nut, is mounted flush and securely to the threaded end (230) of the mounting portion (23) of the pintle (20) and holds the position of the pintle (20) in the rotating bracket (30).

The washers (37) are mounted respectively between the fixing element (36) and the positioning element (35), securing elements and the axial and keyed ends of the rotating bracket (30).

The stationary leaves (40) are separately mounted in the base (61) of the portable electronic device (60), and are pivotally mounted around the rotating bracket (30). Each stationary leaf (40) may be “L” shaped and has a through hole (420) respectively mounted rotationally around the keyed and the axial ends of the rotating bracket (30) and an optional rotational limit (421) abutting the semi-circular recess (320) of the corresponding spacer (32). The stationary leaf (40) mounted around the axial end of the rotating bracket (30) may have at least one mounting recess and may also comprise a limiting protrusion (421) mounted in the semi-circular recess that restricts the rotational movement of the rotating bracket (30).

The securing elements (43) may be a gasket, are mounted on the key (33) and hold the rotating bracket (30) in the stationary leaves (40) with a riveting manner.

The securing elements (44) may be a nut, are mounted respectively on the threaded end (340) of the axle (34) and hold the rotating bracket (30) in the stationary leaves (40) with a threading manner.

The retaining assembly (50) comprises an inner retaining element (51), an outer retaining element (52) and a resilient element (53).

The inner retaining element (51) is mounted securely in the stationary leaf (40) at the axial end of the rotating bracket (30) and has a through hole (511) and two inner teeth (512). The through hole (511) is formed through the inner retaining element (51) and rotatably mounts around the axle (34). The inner teeth (512) protrude away from the rotating bracket (30), parallel to the rotational axis, and each inner tooth (512) has two sloping side edges. The outer retaining element (52) is slidably mounted on the axle (34) and has an engaging hole (520) and two outer teeth (521). The engaging hole (520) is formed through the outer retaining element (52), is keyed to engage with the keyed surface of the axle (34) so the outer retaining element (52) simultaneously rotates with the axle (34). The outer teeth (521) protrude towards the rotating bracket (30), parallel to the rotational axis and each outer tooth (521) has two sloping side edges. The resilient element (53) is mounted around the axle (34) between the securing element (44) and the outer retaining element (52) and pushes the outer retaining element (52) toward the inner retaining element (51), such that the outer teeth (521) will sequentially engage with the inner teeth (512) to selectively hold the cover (62) in a folded position or an unfolded position.

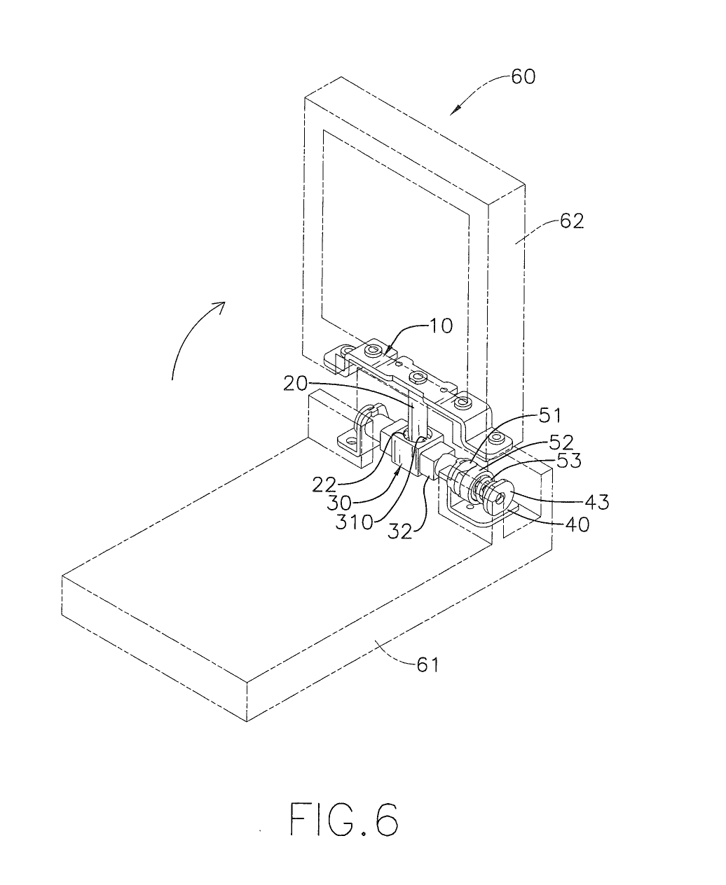

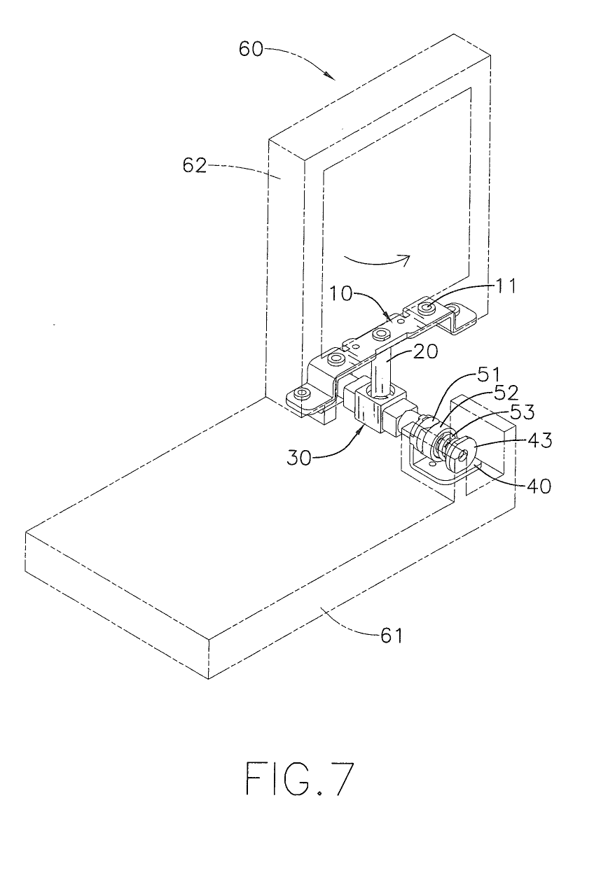

With reference to FIGS. 1, 5, 6 and 7, since the limit (22) and the positioning element (35) are arranged inside the rotating bracket (30), when the hinge assembly in accordance with present invention is operating, the limit (22) and the positioning element (35) are not exposed. Therefore, abrasion or interference between wires or cableways and the pintle (20) or positioning element (35) are prevented. Therefore the hinge assembly in accordance with present invention is guaranteed to last a long time and move smoothly.

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. A hinge assembly comprising
a pivoting leaf having multiple securing holes formed through the pivoting leaf;
a pintle having
a cover end being attached to the pivoting leaf;
a base end having a mounting portion formed on and protruding longitudinally from the base end, being keyed and having an end; and
a limit being formed on and protruding radially out from the base end of the pintle;
a rotating bracket having
two ends;
an upper side;
a lower side;
a limiting recess mounted around the base end of the pintle being formed transversely in the upper side of the rotating bracket and having
an inner surface; and
a positive stop being formed on and protruding from the inner surface and selectively abutting the limit on the pintle;
a countersink being formed in the lower side of the rotating bracket and having
an inner surface; and
a rotational detent being diametrically formed in the inner surface;
a central hole being defined through the gudgeon concentrically to and communicating with both the countersink and the limiting recess and rotationally mounting around the mounting portion of the pintle;
a positioning element being mounted in the countersink and being able to simultaneously rotate with the pintle and having
an inner surface;
an engaging hole engaging with the mounting portion of the pintle; and
a ridge being diametrically formed on the inner surface of the positioning element and selectively engaging the rotational detent of the countersink to retain a position of the pivoting leaf relative to the rotating bracket.

2. The hinge assembly as claimed in claim 1, wherein
the rotating bracket further has
two spacers being formed on and protruding respectively from the ends of the rotating bracket, and each spacer having an end surface;
a key being formed on and protruding from the end surface of one of the spacers; and
an axle being formed on and protruding from the end surface of the other spacer; and
the hinge assembly further has two stationary leaves respectively having a through hole being rotationally mounted around the key and the axle of the rotating bracket.

3. The hinge assembly as claimed in claim 2 further comprising a retaining assembly comprising
an inner retaining element being mounted securely in the stationary leaf and having
a through hole being formed through the inner retaining element and being rotatably mounted around the axle; and
two inner teeth protruding away from the rotating bracket, being parallel to the rotational axis and each inner tooth having two sloping side edges;
an outer retaining clement being slidably mounted on the axle and having
an engaging hole being formed through the outer retaining element, being keyed and engaging with the axle so the outer retaining element is rotating simultaneously with the axle; and
two outer teeth protruding towards the rotating bracket, being parallel to the rotational axis and each outer tooth having two sloping side edges; and
a resilient element being mounted around the axle and pushing the outer retaining element toward the inner retaining element.

4. The hinge assembly as claimed in claim 3, wherein the block spacers further have a semi-circular recess formed on the surface and the stationary leaves have a protrusion mounted in the semi-circular recess that restricts the rotational movement of the rotating bracket.

5. The hinge assembly as claimed in claim 4, wherein the pintle further has a threaded end; and
the hinge assembly further has a fixing element being mounted flush and securely to the threaded end of the pintle and holding the position of the pintle in the rotating bracket.

6. The hinge assembly as claimed in claim 5, wherein the spacers further are cylindrical.

7. The hinge assembly as claimed in claim 5, wherein each stationary leaf further is “L” shaped.
